(19) United States
(12) Patent Application Publication
(10) Pub. No.: US 2015/0103054 A1
(43) Pub. Date: Apr. 16, 2015

(54) PHOTOELECTRIC TOUCH ASSEMBLY, PHOTOELECTRIC TOUCH METHOD AND PROJECTOR WITH TOUCH FUNCTION

(71) Applicant: Touchjet Pte. Ltd., Singapore (SG)

(72) Inventors: JIANG LI, Singapore (SG); ZHEN LIU, Auckland City (NZ)

(21) Appl. No.: 14/514,367

(22) Filed: Oct. 14, 2014

(30) Foreign Application Priority Data
Oct. 14, 2013 (CN) 201320634347.2
Apr. 4, 2014 (CN) 201410138790.X

(51) Int. Cl. G06F 3/042; G03B 21/14

(52) U.S. Cl. CPC G06F 3/0421; G03B 21/14
USPC 345/175

(57) ABSTRACT

A photoelectric touch assembly, a photoelectric touch method and a projector with touch function are provided. The photoelectric touch assembly comprises a light-spot emitting unit, an image capturing unit, an image processing unit and an Android-System unit. The light-spot emitting unit is configured to emit a light for forming at least one light spot on a display surface. The image capturing unit faces towards the display surface and has a field of view that completely covers the display surface, for capturing image data of the light spot or a trajectory formed by the light spot moving. The image processing unit is connected to the image capturing unit for convert the image data into a corresponding touch signal. The Android-System unit is connected to the image processing unit for receiving the touch signal and performing a corresponding operation according to the touch signal.

### CROSS-REFERENCE OF RELATED APPLICATIONS

This application is based upon and claims the benefit of priority from the prior China Patent Application No. 201320634347.2, filed Oct. 14, 2013, and the prior China Patent Application No. 201410138790.X, filed Apr. 4, 2014, the entire contents of which are incorporated herein by reference.

### BACKGROUND

1. Technical Field

The present invention relates to the human-machine interacting technology, and more particularly to a photoelectric touch assembly, a corresponding photoelectric touch method and a corresponding projector with touch function.

2. Description of the Related Art

With advancement of the society and development of the electronic technologies, the touch screen technology has found wide application. A display device with a touch screen typically comprises a display panel and a touch screen disposed above the display panel to perform the touch function. The touch screen may be divided into resistive touch screen, capacitive touch screen, infrared touch screen and surface acoustic touch screen according to the medium used therein and the working principle thereof. Among these touch screens, the resistive touch screen and the capacitive touch screen are commonly used, but they need a sensing circuit disposed on the panel, which makes the structure and the manufacture process complex.

In addition, for some display devices, such as projectors or TV sets which have a display screen with large sizes, they do not need complex and accurate touch operations, and only need some simple touch operations to perform some simple human-machine interacting functions. Therefore, if these display devices use the conventional touch technology, it will greatly increase the cost thereof.

Therefore, there is a need to provide a photoelectric touch assembly, a corresponding photoelectric touch method and a corresponding projector with touch function, for solving the above problems.

### SUMMARY

The present disclosure relates to a photoelectric touch assembly, a photoelectric touch method and a projection, which can perform a touch function and implement a human-machine interacting operation with a simple structure and a low cost.

The present disclosure relates to a photoelectric touch assembly, which comprises a light-spot emitting unit, an image capturing unit, an image processing unit and an Android-System unit. The light-spot emitting unit is configured to emit a light for forming at least one light spot on a display surface. The image capturing unit faces towards the display surface and has a field of view that completely covers the display surface, for capturing an image of the light spot or images of a trajectory formed by the light spot moving. The image processing unit is connected to the image capturing unit for receiving the image of the light spot or the images of the trajectory formed by the light spot moving, and converting image data related to the light spot or the trajectory into a corresponding touch signal. The Android-System unit has the Android system as an operating system thereof, and is connected to the image processing unit for receiving the touch signal and performing a corresponding operation according to the touch signal.

Preferably, the light-spot emitting unit is an infrared-ray emitting unit, and the image capturing unit is an infrared camera.

Preferably, the display surface is a projection screen of a projector or a display screen of a TV set, and the projector or the TV set displays image frames corresponding to display signals of the Android-System unit on the display surface.

Preferably, the image capture unit, the image processing unit and the Android-System unit of the photoelectric touch assembly are independent from the projector or the TV set.

Preferably, the image capture unit, the image processing unit and the Android-System unit of the photoelectric touch assembly are integrated into the projector or the TV set.

Preferably, the photoelectric touch assembly further comprises a camera support, which is assembled on the projection screen of the projector or the display screen of the TV set, for fixing the image capturing unit on the projection screen of the projector or the display screen of the TV set and making the image capturing unit facing towards the projection screen of the projector or the display screen of the TV set.

Preferably, the camera support is detachably mounted on the projection screen of the projector or the display screen of the TV set.

Preferably, the image capturing unit is detachably mounted on the camera support.

Preferably, the camera support is foldable.

The present disclosure also relates to a photoelectric touch method, which comprises: forming at least one light spot on a display surface by a light-spot emitting unit; capturing an image of the light spot or images of a trajectory formed by the light spot moving by an image capturing unit; converting image data related to the light spot or the trajectory into a corresponding touch signal by an image processing unit; and performing a corresponding operation according to the touch signal by an Android-System unit.

The present disclosure further relates to a projector with touch function, which comprises a projection assembly, a driving board and a photoelectric touch assembly. The driving board is connected to the projection assembly. The photoelectric touch assembly comprises a light-spot emitting unit, an image capturing unit, an image processing unit and an Android-System Unit. The light-spot emitting unit is configured to emit a light for forming at least one light spot on a projection screen of the projector. The image capturing unit faces towards the projection screen and has a field of view that completely covers the projection screen, for capturing an image of the light spot or images of a trajectory formed by the light spot moving. The image processing unit is connected to the image capturing unit for receiving the image of the light spot or the images of the trajectory formed by the light spot moving, and converting image data related to the light spot or the trajectory into a corresponding touch signal. The Android-System unit has the Android system as an operating system thereof, and is connected to the image processing unit and the driving board for performing a corresponding operation according to the touch signal and controlling the projection assembly to display a corresponding image frame on the projection screen via the driving board.

Preferably, the projector further comprises a housing. The image capturing unit, the image processing unit and the Android-System unit of the photoelectric touch assembly, the projector assembly, and the driving board are disposed inside the housing.

Preferably, the light-spot emitting unit is an infrared-ray emitting unit, and the image capturing unit is an infrared camera.

Preferably, the projector further comprises a multi-interface unit, and the driving board is further connected to the multi-interface unit so that the driving board further acquires image data from an external component via the multi-interface.

Preferably, the projector further comprises a power-supply interface and a power-supply processing unit. The power-supply processing unit is connected to the projection assembly, the driving board, and the image capturing unit, the image processing unit and the Android-System unit of the photoelectric touch assembly, and the power-supply interface is connected to the power-supply processing unit so as to provide an external power to the projection assembly, the driving board, and the image capturing unit, the image processing unit and the Android-System unit of the photoelectric touch assembly via the power-supply processing unit.

Preferably, the projector further comprises a power-supply processing unit and a built-in power supply. The power-supply processing unit is connected to the projection assembly, the driving board, and the image capturing unit, the image processing unit and the Android-System unit of the photoelectric touch assembly, and the built-in power supply is connected to the power-supply processing unit so as to provide a power to the projection assembly, the driving board, and the image capturing unit, the image processing unit and the Android-System unit of the photoelectric touch assembly via the power-supply processing unit.

Preferably, the built-in power supply is a chargeable battery, and the projector further comprises a power-supply interface connected to the built-in power supply for charging the built-in power supply.

Preferably, the projector further comprises a network interface connected to the Android-System unit.

The photoelectric touch assembly, the photoelectric touch method and the projector employs the light-spot emitting unit to form at least one light spot on the display surface, captures the image data of the light spot or the trajectory formed by the light spot moving by the image capturing unit, converts the image data into the touch signal by the image processing unit, and perform the operation according to the touch signal by the Android-System unit. Therefore, any type of TV sets or projectors may be amended to have the touch function to implement the human-machine interacting operation without modifying the original structures thereof, the structure and the manufacturing process thereof are simple, and the cost thereof is low.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic principle view of a photoelectric touch assembly according to an exemplary embodiment of the present disclosure.

FIG. 2 is a schematic circuit view of the photoelectric touch assembly as shown in FIG. 1.

FIG. 3 is a schematic view for illustrating an installation means of the image capturing unit of the photoelectric touch assembly in accordance with an exemplary embodiment of the present disclosure.

FIG. 4 is a flowchart of a photoelectric touch method according to an exemplary embodiment of the present disclosure.

FIG. 5 is a schematic principle view of a projector according to an exemplary embodiment of the present disclosure.

FIG. 6 is a schematic principle view of a projector according to another exemplary embodiment of the present disclosure.

### DETAILED DESCRIPTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

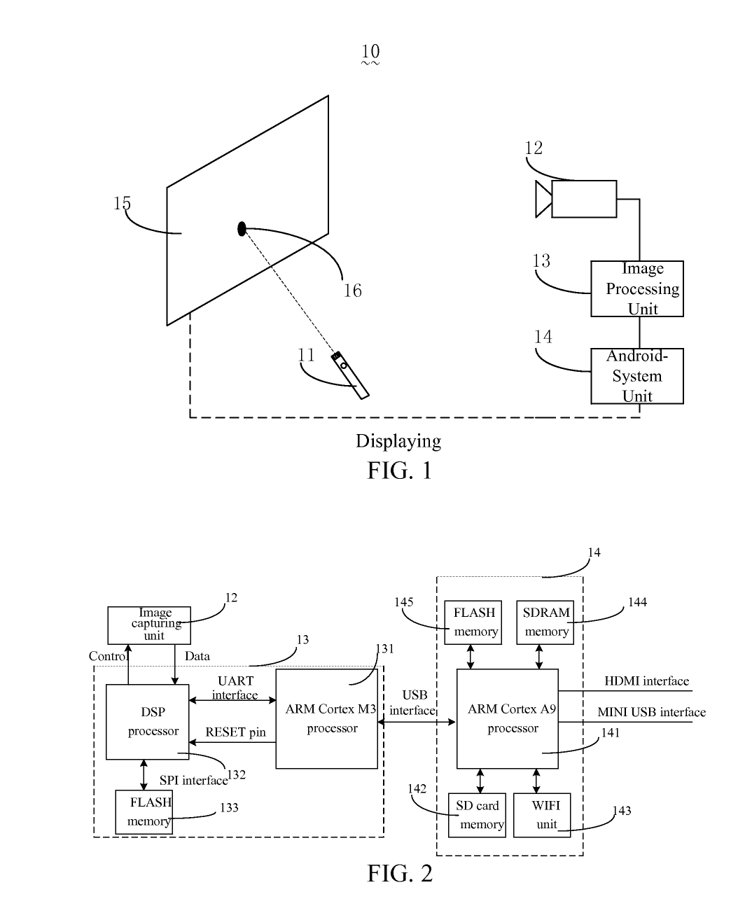

Refer to FIG. 1, which is a schematic principle view of a photoelectric touch assembly according to an exemplary embodiment of the present disclosure. In this exemplary embodiment, the photoelectric touch assembly 10 comprises a light-spot emitting unit 11, an image capturing unit 12, an image processing unit 13 and an Android-System unit 14 installing the Android system as an operation system.

The light-spot emitting unit 11 is configured to emit a light for forming at least one light spot 16 on a display surface 15. Preferably, the light-spot emitting unit 11 may be an infrared-ray emitting unit configured to emit an infrared ray for forming at least one infrared light spot 16 on the display surface 15. In this exemplary embodiment, the light-spot emitting unit 11 is an infrared pen. Alternatively, the light-spot emitting unit 11 may also be other devices configured to emit the light.

The image capturing unit 12 faces towards the display surface 15 and has a field of view that completely covers the display surface 15. The image capturing unit 12 is configured to capture an image of the light spot 16 or images of a trajectory formed by the light spot 16 moving. Preferably, the image capturing unit 12 may be an infrared camera to correspond to the infrared-ray emitting unit 11.

The image processing unit 13 is electrically connected to the image capturing unit 12, and configured to receive the image of the light spot 16 or the images of the trajectory formed by the light spot 16 moving, and convert image data related to the light spot or the trajectory into a corresponding touch signal.

The Android-System unit 14 is electrically connected to the image processing unit 13, and configured to receive the touch signal and perform a corresponding operation according to the touch signal. In this exemplary embodiment, the Android-System unit 14 may have an embedded system using the Android system as the operating system, and does not comprise a touch screen. Alternatively, the Android-System unit 14 may also be provided with a touch screen, for example, the Android-System unit 14 may be a mobile phone or a tablet computer or the like.

Preferably, the display surface 15 is a projection screen of a projector or a display screen of a TV set which have a display screen with a large size, the projector or the TV set is electrically connected to the Android-System unit 14 to display image frames corresponding to display signals of the Android-System unit 14 on the display surface 15.

In this exemplary embodiment, the user holds the light-spot emitting unit 11, such as the infrared pen by a hand to form the infrared light spot 16 on the display surface 15 or move the infrared light spot 16 to form the trajectory on the display surface 15 according to a touch idea of the user. Then image data related to the infrared light spot 16 or the trajectory formed by the infrared light spot 16 moving, is captured by the image capture unit 12, and the image data is transmitted from the image capture unit 12 to the image processing unit 13. The image processing unit 13 converts the image data into a corresponding touch signal, and transmits the touch signal to the Android-System unit 14, such that the Android-System unit 14 performs a corresponding operation according to the touch signal.

For example, when the display surface 15 is displaying an image frame, the user uses the light-spot emitting unit 11 to form the infrared light spot 16 on a certain portion of the current image frame of the display surface 15, which may be a menu for next page. The image capture unit 12 captures the image data related to the infrared light spot 16, and the image processing unit 13 converts the image data to a corresponding touch signal. Finally, the Android-System unit 14 receives the touch signal and performs an operation of displaying a next image frame according to the touch signal, thus the display surface 15 displays the next image frame to perform the human-machine interacting operation.

Similarly, the user also may uses the light-spot emitting unit 11 to form a trajectory formed by the infrared light spot 16 moving, which may correspond to a touch signal for displaying a next image frame, thus the Android-System unit 14 displays the next image frame on the display surface 15 to perform the human-machine interacting operation.

Preferably, the image capture unit 12 is installed right in front of the display surface 15. The image capture unit 12, the image processing unit 13 and the Android-System unit 14 may be integrated together; or any two of them may be integrated together. Alternatively, the image capture unit 12, the image processing unit 13 and the Android-System unit 14 may be independent from each other. In other embodiments, the image capture unit 12, the image processing unit 13 and the Android-System unit 14 may be three conventional apparatus respectively, such as a camera, an image processor and a mobile phone, which are connected via cables.

Furthermore, the image capture unit 12, the image processing unit 13 and the Android-System unit 14 of the photoelectric touch assembly 10 may be independent from the projector or the TV set. Thus any conventional projector or TV set may perform the touch operation and implement the human-machine function by adding the photoelectric touch assembly 10 thereon. Alternatively, the image capture unit 12, the image processing unit 13 and the Android-System unit 14 of the photoelectric touch assembly 10 also may be integrated into the projector or the TV set.

Refer to FIG. 2, which is a schematic circuit view of the photoelectric touch assembly as shown in FIG. 1. As shown in FIG. 2, the image capturing unit 12 is preferably an infrared camera; the image processing unit 13 preferably comprises an ARM Cortex M3 processor 131, a DSP processor 132 and an FLASH memory 133; and the Android-System unit 14 comprises an ARM Cortex A9 processor 141, an SD card memory 142, a WIFI unit 143, a SDRAM memory 144 and an FLASH memory 145.

The image capturing unit 12 is connected with the DSP processor 132 by a wire mode or a wireless mode. The DSP processor 132 controls the image capturing unit 12 and the image capturing unit 12 transmits image data to the DSP processor 132.

The DSP processor 132 is connected to the ARM Cortex M3 processor 131 via a URAT interface, and an RESET pin of the DSP processor 132 is also connected to the ARM Cortex M3 processor 131. The DSP processor 132 is connected to the FLASH memory 133 via an SPI interface.

The ARM Cortex M3 processor 131 of the image processing unit 13 is connected to the ARM Cortex A9 processor 141 of the Android-System unit 14 via a USB interface. The SD card memory 142, the WIFI unit 143, the SDRAM memory 144 and the FLASH memory 145 are connected to the ARM Cortex A9 processor 141 respectively. Furthermore, the ARM Cortex A9 processor 141 of the Android-System unit 14 further comprises an HDMI interface and a MINI USB interface such that the Android-System unit 14 is able to be connected to the projector or the TV set via the HDMI interface or the MINI-USB interface thereof.

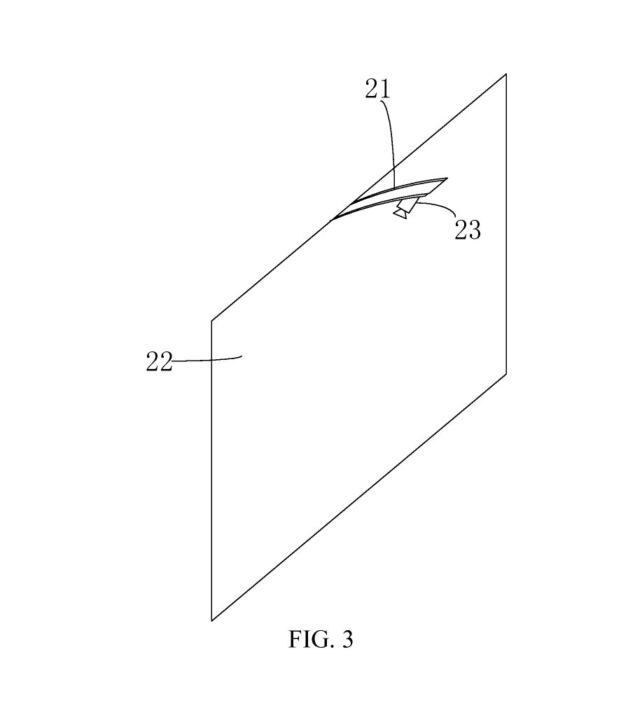

Refer to FIG. 3, which is a schematic view for illustrating an installation means of the image capturing unit of the photoelectric touch assembly according to an exemplary embodiment of the present disclosure. In this exemplary embodiment, the display surface is a display screen 22 of a TV set, and the photoelectric touch assembly further comprises a camera support 21 assembled on the display screen 22 of the TV set and configured to fix the image capturing unit 23 on the display screen 22 of the TV set and make the image capturing unit 23 facing towards the display screen 22 of the TV set.

Preferably, the camera support 21 may be fixed on a frame of the display screen 22 of the TV set. In addition, the camera support 21 may be detachably mounted on the display screen 22 of the TV set such that the camera support 21 will not occupy excessive spaces when not being used. Similarly, the image capturing unit 23 may be also detachably mounted on the camera support 21. In other embodiments, the camera support 21 is foldable so that it can be folded up when not being used so as not to occupy excessive spaces.

Furthermore, in other embodiments, the display surface also may be a projection screen of a projector, and the camera support 21 may be mounted on the projection screen of the projector to fix the image capturing unit 23 on the projection screen.

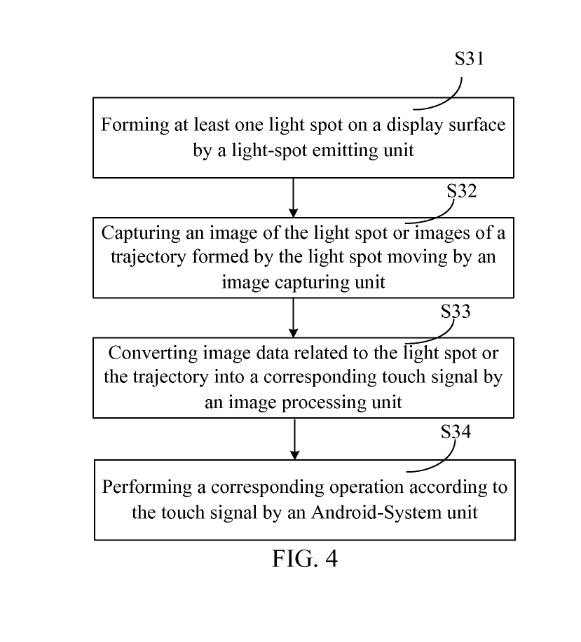

Refer to FIG. 4, which is a flowchart of a photoelectric touch method according to an exemplary embodiment of the present disclosure. In this exemplary embodiment, the photoelectric touch method comprises:

Step S31: forming at least one light spot on a display surface by a light-spot emitting unit.

As shown in FIGS. 1 and 4, the light-spot emitting unit 11 may be an infrared-ray emitting unit, such as an infrared pen. The display surface 15 may be a projection screen of a projector or a display screen of a TV set.

Step S32: capturing an image of the light spot or images of a trajectory formed by the light spot moving by an image capturing unit.

As shown in FIGS. 1 and 4, the image capturing unit 12 may be an infrared camera, and faces towards the display surface 15 and has a field of view that completely covers the display surface 15.

Step S33: converting image data related to the light spot or the trajectory into a corresponding touch signal by an image processing unit.

Step S34: performing a corresponding operation according to the touch signal by an Android-System unit.

As shown in FIGS. 1 and 4, the Android-System unit 14 has an embedded system using the Android system as the operating system thereof.

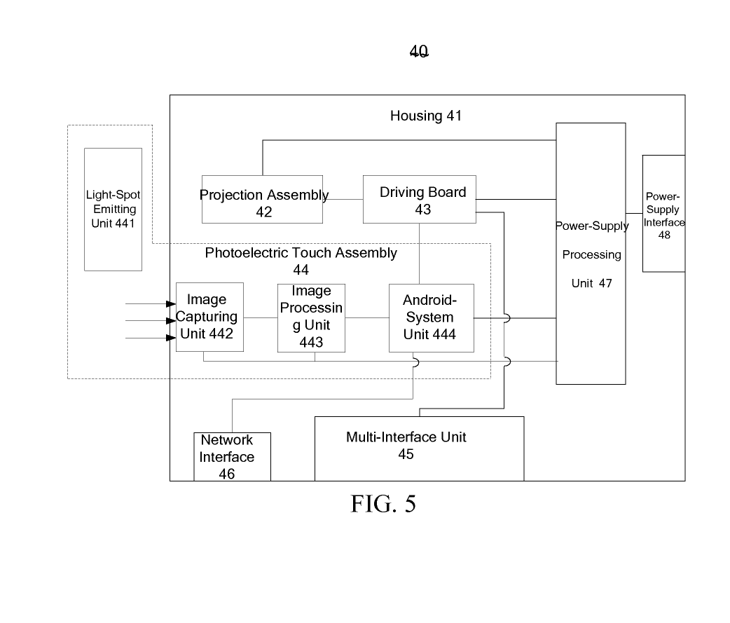

Refer to FIG. 5, which is a schematic principle view of a projector with touch function according to an exemplary embodiment of the present disclosure. In this exemplary embodiment, the projector 40 employs the photoelectric touch assembly as shown in FIG. 1 to perform human-machine interacting operation. In detail, as shown in FIG. 5, the projection 40 comprises a housing 41, a projection assembly 42, a driving board 43, a photoelectric touch assembly 44, a multi-interface unit 45, a network interface 46, a power-supply processing unit 47 and a power-supply interface 48.

The driving board 43 is connected to the projection assembly 42 to drive the projection assembly 42 to display image frames on a projection screen of the projector 40.

The photoelectric touch assembly 44 comprises a light-spot emitting unit 441, an image capturing unit 442, an image processing unit 443 and an Android-System unit 444. The light-spot emitting unit 441 is configured to emit a light for forming at least one light spot on a projection screen of the projector 40. Preferably, the light-spot emitting spot 441 may be an infrared-ray emitting unit, such as an infrared pen. The image capturing unit 442 faces towards the projection screen and has a field of view that completely covers the projection screen, and configured to capture an image of the light spot or images of a trajectory formed by the light spot moving. Preferably, the image capturing unit 442 may be an infrared camera. The image processing unit 443 is connected to the image capturing unit and configured to receive the image of the light spot or the images of the trajectory formed by the light spot moving, and convert image data related to the light spot or the trajectory into a corresponding touch signal. The Android-System unit 444 has an embedded system using the Android System as an operating system thereof, and is connected to the image processing unit 443 and the driving board 43. The Android-System unit 444 is configured to perform a corresponding operation according to the touch signal and control the projection assembly 42 to display a corresponding image frame on the projection screen via the driving board 43.

In this exemplary embodiment, the projection assembly 42, the driving board 43, and the image capturing unit 442, the image processing unit 443 and the Android-System unit 444 of the photoelectric touch assembly 44 are disposed inside the housing 41. That is, the image capturing unit, the image processing unit and the Android-System unit of the photoelectric touch assembly as shown in FIG. 1 are integrated into the projector. Alternatively, in other embodiments, they also may be independent from the projector.

In addition, in this exemplary embodiment, the Android-System unit 444 may be an IC (integrated circuit) board, which has the various components as shown in FIG. 2 installed thereon. Similarly, the image processing unit 443 also may be an IC board, which has the various components as shown in FIG. 2 installed thereon. Preferably, the image processing unit 443 and the Android-System unit 444 may be integrated into a circuit board.

The driving board 43 is further connected to the multi-interface unit 45, such that the driving board 43 of the projector 40 is able to acquire image data from an external component via the multi-interface unit 45, and control the displaying of the projection assembly 42 according to the image data from the external component. Here, the external component may be a computer or the like. Thus the projector 40 of the present disclosure not only projects image frames from the computer, but also acquire image data from the Android-System unit 444 to project corresponding image frame. The projection assembly 42 comprises an LED light source, a lens, a digital optical processing chip and so on.

The network interface 46 is connected to the Android-System unit 444 so that the Android-System unit 444 can be communicated with the Internet to acquire image data from the Internet. In other embodiments, the network interface 46 also may be a wireless network card. Furthermore, the projector 40 may further comprises a memory connected with the Android-System unit 444 to store data that is being processed or to be processed by the Android-System unit 44.

The power-supply interface 48 is connected to the power-supply processing unit 47, and the power-supply processing unit 47 is connected to the projection assembly 42, the driving board 43, and the image capturing unit 442, the image processing unit 443 and the Android-System unit 444 of the photoelectric touch assembly 44. Thus the power-supply interface 48 can be connected to an external power source to provide an external power to the projection assembly 42, the driving board 43, and the image capturing unit 442, the image processing unit 443 and the Android-System unit 444 of the photoelectric touch assembly 44.

In use, the light-spot emitting unit 441 is held by the user, to form at least one light spot on the projection screen of the projector 40, or move the light spot to form a trajectory thereon. The image capturing unit 442 captures the image data related to the light spot or the trajectory, and the image processing unit 443 convert the image data into a corresponding touch signal and transmits the touch signal to the Android-System unit 444, thus the Android-System unit 444 performs the corresponding operation according to the touch signal, such as displaying an next image frame, to implement the human-machine interacting operation.

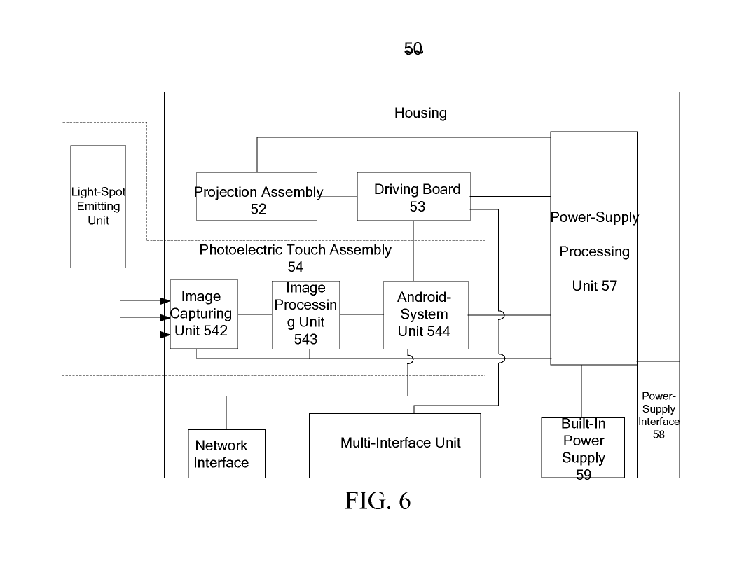

Refer to FIG. 6, which is a schematic principle view of a projector according to another exemplary embodiment of the present disclosure. In this exemplary embodiment, the projector 50 is similar with the projector 40 as shown in FIG. 5, except that the projector 50 further comprises a built-in power supply 59. The power-supply processing unit 57 is connected to the built-in power supply 59, and the built-in power supply 59 is further connected to the power-supply interface 58. The built-in power supply 59 may be a chargeable battery. That is, the built-in power supply 59 supplies an power to the projection assembly 52, the driving board 53, and the image capturing unit 542, the image processing unit 543 and the Android-System unit 544 of the photoelectric touch assembly 54 via the power-supply processing unit 57. In addition, the built-in power supply 59 may be charged by the external power supply via the power-supply interface 58.

In summary, the photoelectric touch assembly, the photoelectric touch method and the projector employs the light-spot emitting unit to form at least one light spot on the display surface, captures the image data of the light spot or the trajectory formed by the light spot moving by the image capturing unit, converts the image data into the touch signal by the image processing unit, and perform the operation according to the touch signal by the Android-System unit. Therefore, any type of TV sets or projectors may be amended to have the touch function to implement the human-machine interacting operation without modifying the original structures thereof, the structure and the manufacturing process thereof are simple, and the cost thereof is low.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A photoelectric touch assembly, comprising:
a light-spot emitting unit, configured to emit a light for forming at least one light spot on a display surface;
an image capturing unit, facing towards the display surface and having a field of view that completely covers the display surface, for capturing an image of the light spot or images of a trajectory formed by the light spot moving;
an image processing unit, connected to the image capturing unit for receiving the image of the light spot or the images of the trajectory formed by the light spot moving, and converting image data related to the light spot or the trajectory into a corresponding touch signal; and
an Android-System unit, having the Android system as an operating system thereof, and connected to the image processing unit for receiving the touch signal and performing a corresponding operation according to the touch signal.

2. The photoelectric touch assembly as claimed in claim 1, wherein the light-spot emitting unit is an infrared-ray emitting unit, and the image capturing unit is an infrared camera.

3. The photoelectric touch assembly as claimed in claim 1, wherein the display surface is a projection screen of a projector or a display screen of a television (TV) set, and the projector or the TV set displays image frames corresponding to display signals of the Android-System unit on the display surface.

4. The photoelectric touch assembly as claimed in claim 3, wherein the image capture unit, the image processing unit and the Android-System unit of the photoelectric touch assembly are independent from the projector or the TV set.

5. The photoelectric touch assembly as claimed in claim 3, wherein the image capture unit, the image processing unit and the Android-System unit of the photoelectric touch assembly are integrated into the projector or the TV set.

6. The photoelectric touch assembly as claimed in claim 3, further comprising:
a camera support, assembled on the projection screen of the projector or the display screen of the TV set, for fixing the image capturing unit on the projection screen of the projector or the display screen of the TV set and making the image capturing unit facing towards the projection screen of the projector or the display screen of the TV set.

7. The photoelectric touch assembly as claimed in claim 6, wherein the camera support is detachably mounted on the projection screen of the projector or the display screen of the TV set.

8. The photoelectric touch assembly as claimed in claim 6, wherein the image capturing unit is detachably mounted on the camera support.

9. The photoelectric touch assembly as claimed in claim 6, wherein the camera support is foldable.

10. A photoelectric touch method, comprising:
forming at least one light spot on a display surface by a light-spot emitting unit;
capturing an image of the light spot or images of a trajectory formed by the light spot moving by an image capturing unit;
converting image data related to the light spot or the trajectory into a corresponding touch signal by an image processing unit; and
performing a corresponding operation according to the touch signal by an Android-System unit.

11. A projector with touch function, comprising:
a projection assembly;
a driving board, connected to the projection assembly;
a photoelectric touch assembly, comprising:
a light-spot emitting unit, configured to emit a light for forming at least one light spot on a projection screen of the projector;
an image capturing unit, facing towards the projection screen and having a field of view that completely covers the projection screen, for capturing an image of the light spot or images of a trajectory formed by the light spot moving;
an image processing unit, connected to the image capturing unit for receiving the image of the light spot or the images of the trajectory formed by the light spot moving, and converting image data related to the light spot or the trajectory into a corresponding touch signal; and
an Android-System unit having the Android system as an operating system thereof, connected to the image processing unit and the driving board, for performing a corresponding operation according to the touch signal and controlling the projection assembly to display a corresponding image frame on the projection screen via the driving board.

12. The projector as claimed in claim 11, further comprising a housing, wherein the image capturing unit, the image processing unit and the Android-System unit of the photoelectric touch assembly, the projector assembly, and the driving board are disposed inside the housing.

13. The projector as claimed in claim 12, wherein the light-spot emitting unit is an infrared-ray emitting unit, and the image capturing unit is an infrared camera.

14. The projector as claimed in claim 12, further comprising a multi-interface unit, wherein the driving board is further connected to the multi-interface unit so that the driving board further acquires image data from an external component via the multi-interface.

15. The projector as claimed in claim 12, further comprising a power-supply interface and a power-supply processing unit, wherein the power-supply processing unit is connected to the projection assembly, the driving board, and the image capturing unit, the image processing unit and the Android-System unit of the photoelectric touch assembly, and the power-supply interface is connected to the power-supply processing unit so as to provide an external power to the projection assembly, the driving board, and the image capturing unit, the image processing unit and the Android-System unit of the photoelectric touch assembly via the power-supply processing unit.

16. The projector as claimed in claim 12, further comprising a power-supply processing unit and a built-in power supply, wherein the power-supply processing unit is connected to the projection assembly, the driving board, and the image capturing unit, the image processing unit and the Android-System unit of the photoelectric touch assembly, and the built-in power supply is connected to the power-supply processing unit so as to provide a power to the projection assembly, the driving board, and the image capturing unit, the image processing unit and the Android-System unit of the photoelectric touch assembly via the power-supply processing unit.

17. The projector as claimed in claim 16, wherein the built-in power supply is a chargeable battery, and the projector further comprises a power-supply interface connected to the built-in power supply for charging the built-in power supply.

18. The projector as claimed in claim 12, further comprising a network interface connected to the Android-System unit.
